(19) United States
(12) Patent Application Publication
(10) Pub. No.: US 2020/0012701 A1
(43) Pub. Date: Jan. 9, 2020

(54) METHOD AND APPARATUS FOR RECOMMENDING ASSOCIATED USER BASED ON INTERACTIONS WITH MULTIMEDIA PROCESSES

(71) Applicant: YOUKU INTERNET TECHNOLOGY (BEIJING) CO., LTD., Dongcheng District, Beijing (CN)

(72) Inventors: Diyang HAN, Hangzhou (CN); Yi FANG, Hangzhou (CN); Fei HONG, Hangzhou (CN)

(21) Appl. No.: 16/482,893

(22) PCT Filed: Nov. 24, 2017
(86) PCT No.: PCT/CN2017/112791

§ 371 Date: Aug. 1, 2019

(30) Foreign Application Priority Data
Mar. 2, 2017 (CN) 201710121010.4

(51) Int. Cl. G06F 16/9536; H04L 12/58; G06F 3/0481; H04N 21/466

(52) U.S. Cl. CPC G06F 16/9536; H04L 51/14; H04N 21/4668; G06F 3/04817; H04L 51/32

(57) ABSTRACT

The disclosure relates to a method and an apparatus for recommending an associated user. In one embodiment a method comprises determining a first interactive attribute of a first user based on first interactive data of the first user in a multimedia resource playing process; determining interactive relevance between the first user and a second user according to the first interactive attribute and a second interactive attribute of the second user; and recommending, according to the interactive relevance, the second user associated with the first user. Embodiments according to the disclosure can determine an interactive attribute based on interactive data, determine interactive relevance between a first user and a second user according to the interactive attribute, and further recommend the second user associated with the first user, thereby recommending associated users based on user behavior, improving the accuracy in recommending associated users, and enhancing user experience.

### CROSS REFERENCE TO RELATED APPLICATIONS

This application is the National Stage of, and claims priority to, Int'l Appl. No. PCT/CN17/112791, filed Nov. 24, 2017, which claims priority to Chinese Patent Application No. 201710121010.4 filed on Mar. 2, 2017, both of which are incorporated herein by reference in their entirety.

### BACKGROUND

### Technical Field

The disclosure relates to the field of computer technologies, and in particular, to a method and an apparatus for recommending an associated user.

### Description of the Related Art

On the Internet, there are a large number of users who are strangers to each other. These strangers wish to associate with one another, especially with those who share similar interests and personalities as themselves. Using existing software, such users struggle to effectively discover others who share a degree of similarity and with whom they can have meaningful exchanges.

Therefore, an urgent issue to be solved is how to provide a technical solution that can effectively identify relevance among users and recommend associated users to a first user to allow the user to establish communication with the associated users.

### SUMMARY

In view of this, the disclosure provides a method and an apparatus for recommending an associated user, which can recommend associated users based on user behavior, thereby improving the accuracy in recommending associated users and enhancing user experience.

According to one aspect of the disclosure, a method for recommending an associated user is provided, the method comprising: determining a first interactive attribute of a first user based on first interactive data of the first user in a multimedia resource playing process; determining interactive relevance between the first user and a second user according to the first interactive attribute and a second interactive attribute of the second user; and recommending, according to the interactive relevance, the second user associated with the first user.

According to another aspect of the disclosure, an apparatus for recommending an associated user is provided, the apparatus comprising: a first interactive attribute determination module, used to determine a first interactive attribute of a first user based on first interactive data of the first user in a multimedia resource playing process; a first relevance determination module, used to determine interactive relevance between the first user and a second user according to the first interactive attribute and a second interactive attribute of the second user; and a first user recommendation module, used to recommend, according to the interactive relevance, the second user associated with the first user.

According to another aspect of the disclosure, an apparatus for recommending an associated user is provided, the apparatus comprising: a processor; and a memory used to store processor-executable instructions, wherein the processor is configured to: determine a first interactive attribute of a first user based on first interactive data of the first user in a multimedia resource playing process; determine interactive relevance between the first user and a second user according to the first interactive attribute and a second interactive attribute of the second user; and recommend, according to the interactive relevance, the second user associated with the first user.

According to another aspect of the disclosure, a non-volatile computer-readable storage medium is provided to enable a terminal and/or server to perform the above-described method when instructions in the storage medium are executed by a processor of the terminal and/or server, the method comprising: determining a first interactive attribute of a first user based on first interactive data of the first user in a multimedia resource playing process; determining interactive relevance between the first user and a second user according to the first interactive attribute and a second interactive attribute of the second user; and recommending, according to the interactive relevance, the second user associated with the first user.

The method and apparatus for recommending an associated user according to embodiments of the disclosure can determine an interactive attribute based on interactive data, determine interactive relevance between a first user and a second user according to the interactive attribute, and further recommend the second user associated with the first user, thereby recommending associated users based on user behavior, improving the accuracy in recommending associated users, and enhancing user experience and improving the performance of processes for matching users.

Further features and aspects of the disclosure will be described in more detail in the following detailed description of exemplary embodiments with reference to the accompanying drawings.

### BRIEF DESCRIPTION OF THE DRAWINGS

The accompanying drawings, which are incorporated in and constitute a part of this specification, together with the specification, illustrate exemplary embodiments, features, and aspects of the disclosure and serve to explain the principles of the disclosure.

FIG. 1 is a flow chart illustrating a method for recommending an associated user according to some embodiments of the disclosure.

FIG. 2 is a flow diagram illustrating a method for recommending an associated user according to some embodiments of the disclosure.

FIG. 3 is a flow diagram illustrating a method for recommending an associated user according to some embodiments of the disclosure.

FIG. 4 is a flow diagram illustrating step 12 in a method for recommending an associated user according to some embodiments of the disclosure.

FIG. 5 is a flow diagram illustrating step 13 in a method for recommending an associated user according to some embodiments of the disclosure.

FIG. 6 is a flow diagram illustrating a method for recommending an associated user according to some embodiments of the disclosure.

FIG. 7 is a block diagram illustrating an apparatus for recommending an associated user according to some embodiments of the disclosure.

FIG. 8 is a block diagram illustrating an apparatus for recommending an associated user according to some embodiments of the disclosure.

FIG. 9 is a block diagram illustrating an apparatus for recommending an associated user according to some embodiments of the disclosure.

FIG. 10 is a block diagram illustrating an apparatus for recommending an associated user according to some embodiments of the disclosure.

### DETAILED DESCRIPTION

Various exemplary embodiments, features, and aspects of the disclosure will be described in detail below with reference to the drawings. The same reference signs in the drawings identify elements with the same or similar functions. Although various aspects of embodiments are shown in the drawings, the drawings are not necessarily drawn to scale unless otherwise indicated. The word “exemplary” used herein means “used as an example, embodiment, or illustration” Any embodiment described herein as “exemplary” is not necessarily to be construed as superior to or better than other embodiments. Furthermore, to better illustrate the disclosure, numerous specific details are given in the detailed description of the embodiments below. Those skilled in the art should understand that the disclosure can be implemented even without some specific details. In some examples, to highlight the purport of the disclosure, methods, means, elements and circuits well known to those skilled in the art are not described in detail.

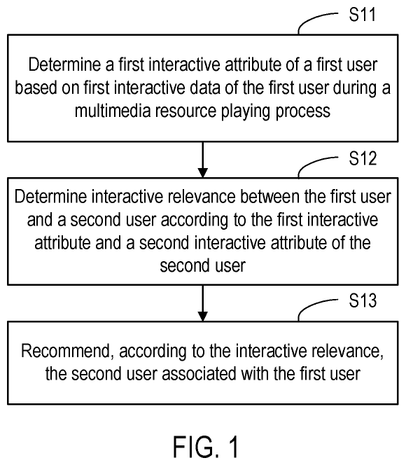

FIG. 1 is a flow diagram illustrating a method for recommending an associated user according to some embodiments of the disclosure.

The method can be applied to a terminal device (such as a smart phone) or a server. As shown in FIG. 1, a method for recommending an associated user includes the following steps.

At step S11, the method determines a first interactive attribute of a first user based on first interactive data of the first user during a multimedia resource playing process.

At step S12, the method determines an interactive relevance between the first user and a second user according to the first interactive attribute and a second interactive attribute of the second user.

At step S13, the method recommends, according to the interactive relevance, the second user associated with the first user.

The method and apparatus for playing a multimedia resource according to embodiments of the disclosure can determine an interactive attribute based on interactive data, determine interactive relevance between a first user and a second user according to the interactive attribute, and further recommend the second user associated with the first user, thereby recommending associated users based on user behavior, improving the accuracy in recommending associated users, and enhancing user experience.

The first interactive data may be interactive data generated when a user conducts any interactive behavior such as commenting, liking, forwarding, etc., of objects such as a multimedia resource or other users in a multimedia resource playing process. The first and second interactive attributes can be any value, statistics, classification result, etc., that can represent attribute features of interactive behavior of the first and second users.

For example, in a multimedia resource (e.g. a video) playing process, a user can input comments, which may be a comment on the entire multimedia resource or on a fragment of the multimedia resource, or may be a comment made at a certain time point during the playing of the multimedia resource. The contents of a comment can include input texts, pictures, emoticons, etc. and, the contents can be displayed in a special comment content display area or displayed in the form of bullet screen (or other mechanism allowing for social commenting on multimedia files) on a play interface of the multimedia resource. The disclosure does not limit the content, input method, and display method of the comment input by the user.

In one embodiment, the first interactive data can comprise a comment icon input by the first user currently watching the multimedia resource in the multimedia resource playing process and corresponding input time. In the multimedia resource playing process, a comment icon input by the first user, (e.g. a comment icon clicked by the first user that represents sadness, delight, or panic) can be acquired. The comment icon input by the first user can be input in real-time, and can be displayed in the form of bullet screen on the play interface of the multimedia resource. Thus, the comment icon input by the first user and corresponding input time can be acquired as the first interactive data.

In one embodiment, the first interactive attribute of the first user comprises one or a plurality of an input frequency of the first user for the first comment icon, an overall input frequency for the plurality of comment icons, an input time distribution for the first comment icon, and an overall input time distribution for the plurality of comment icons, wherein the first comment icon is any one of the plurality of comment icons.

For example, for the first interactive data, the first interactive attribute of the first user can be determined. The first interactive attribute can be icon clicking information of the first user obtained through analysis of various comment icons input by the first user in the multimedia resource playing process, e.g., a clicking frequency of a plurality of comment icons (the overall input frequency for the plurality of comment icons), a clicking frequency of similar comment icons (the input frequency for the first comment icon), a clicking time distribution of similar icons (the input time distribution for the first comment icon), a clicking time distribution of all icons (the overall input time distribution for the plurality of comment icons), etc. The plurality of comment icons can comprise some or all of the comment icons provided on the play interface of the multimedia resource that represent sadness, delight, panic, etc. The first comment icon can comprise any one of the comment icons provided on the play interface of the multimedia resource that represent sadness, delight, panic, etc.

In one embodiment, the interactive relevance between the first user and the second user is acquired by matching the first user and the second user based on the first interactive attribute of the first user currently watching the multimedia resource and the second interactive attribute of the second user currently watching the multimedia resource or having previously watched the multimedia resource, wherein extracted time periods for user matching can be continuous, intermittent, or the full time of the multimedia resource. For example, user A clicks a comment icon of smiling face at a frequency of one click per second from the first minute to the second minute, and clicks a comment icon of crying face at a frequency of nine clicks every ten seconds from the fifth minute to the seventh minute; user B clicks the comment icon of smiling face at a frequency of nine clicks every ten seconds from the first minute to the second minute, and clicks the comment icon of crying face at a frequency of one click per second from the fifth minute to the seventh minute. The input frequencies of both users for similar icons in the two time periods are similar, and it can therefore be considered that the first interactive attribute of the first user A (e.g., user A's input frequency for the smiling-face comment icon and input frequency for the crying-face comment icon) and the second interactive attribute of the second user B (e.g., user B's input frequency for the smiling-face comment icon and input frequency for the crying-face comment icon) are relatively similar, and it can be determined that the interactive relevance between the first user A and the second user B is relatively high.

In one embodiment, the second user associated with the first user can be recommended according to the interactive relevance. For example, in the above example, the interactive relevance between the first user A and the second user B is relatively high. Therefore, the second user B, as a user associated with the first user, can be recommended to the first user A. This approach can recommend associated users based on user behavior, thereby improving the accuracy in recommending associated users and enhancing user experience.

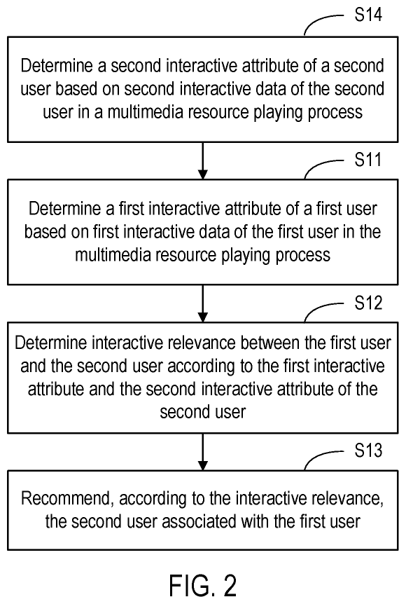

FIG. 2 is a flow diagram illustrating a method for recommending an associated user according to some embodiments of the disclosure.

As shown in FIG. 2, in one embodiment, the method further comprises, at step S14, determining the second interactive attribute of the second user based on second interactive data of the second user in the multimedia resource playing process.

For example, the second user can be another user currently watching the multimedia resource or a plurality of users having previously watched the multimedia resource. In the multimedia resource playing process, a comment icon input by the second user, (e.g. a comment icon clicked by the second user that represents sadness, delight or panic) can be acquired and further used as the second interactive data. The server can identify users currently watching and having previously watched the multimedia resource as second users, determine and save second interactive attributes thereof to match the second users with the first user currently watching the multimedia resource, determine interactive relevance therebetween, and recommend a second user with relatively high interactive relevance thereamong to the first user.

In one embodiment, the second interactive data comprise the comment icon input by the second user in the multimedia resource playing process and corresponding input time. The second interactive attribute comprises one or a plurality of an input frequency of the second user for the first comment icon, an overall input frequency for the plurality of comment icons, an input time distribution for the first comment icon, and an overall input time distribution for the plurality of comment icons, The first comment icon is any one of the plurality of comment icons.

For example, for the second interactive data, the second interactive attribute of the second user can be determined. The second interactive attribute can be icon clicking information of the second user obtained through analysis of various comment icons input by the second user in the multimedia resource playing process, e.g., a clicking frequency of a plurality of comment icons (the overall input frequency for the plurality of comment icons), a clicking frequency of similar comment icons (the input frequency for the first comment icon), a clicking time distribution of similar icons (the input time distribution for the first comment icon), a clicking time distribution of all icons (the overall input time distribution for the plurality of comment icons), etc. The plurality of comment icons can comprise some or all of the comment icons provided on the play interface of the multimedia resource that represent sadness, delight, panic, etc. The first comment icon can comprise any one of the comment icons provided on the play interface of the multimedia resource that represent sadness, delight, panic, etc.

This approach can determine the second interactive attribute of the second user to match the second user with the first user, thereby further improving the accuracy in recommending associated users.

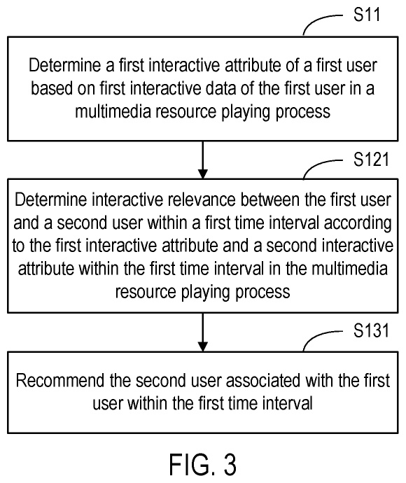

FIG. 3 is a flow diagram illustrating a method for recommending an associated user according to some embodiments of the disclosure.

As shown in FIG. 3, in one embodiment, step S12 comprises, at step S121, determining the interactive relevance between the first user and the second user within a first time interval according to the first interactive attribute and the second interactive attribute within the first time interval in the multimedia resource playing process.

As shown in FIG. 3, in one embodiment, step S13 comprises, at step S131, recommending the second user associated with the first user within the first time interval.

For example, in the multimedia resource playing process, interactive attributes within the first time interval can be analyzed based on comment icons input by users within the first time interval and corresponding input time, wherein the first time interval can be any time interval in the multimedia resource playing process. An overall input frequency for the plurality of comment icons within the first time interval can be analyzed or an input frequency for the first comment icon within the first time interval can be analyzed, so as to determine the interactive relevance between the first user and the second user within the first time interval according to the first interactive attribute and second interactive attribute within the first time interval. For example, if user A clicks the comment icon of smiling face at a frequency of one click per second from the first minute to the second minute, and user B clicks the comment icon of smiling face at a frequency of nine clicks every ten seconds from the first minute to the second minute, then the input frequencies of the two are similar; therefore, it can be considered that the interactive relevance between user A and user B from the first minute to the second minute is relatively high.

In one embodiment, the second user associated with the first user within the first time interval can be recommended according to the interactive relevance. For example, if the interactive relevance between user A and user B from the first minute to the second minute is relatively high (their clicking frequencies for the comment icon of smiling face are similar), then the second user B, as a user associated with the first user A within the first time interval (from the first minute to the second minute), can be recommended to the first user A. Such a recommendation can be a real-time recommendation, e.g., recommending the second user B to the first user A at the second minute during the playing of the multimedia resource.

This approach can determine the interactive relevance of users within a first time interval to recommend associated users, improve the accuracy and timeliness of recommendation, and thereby enhance user experience.

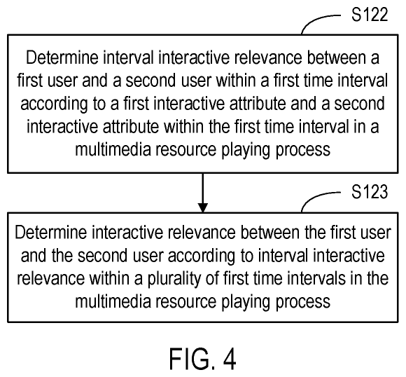

FIG. 4 is a flow diagram illustrating one embodiment of step S12 described above, according to some embodiments of the disclosure.

As shown in FIG. 4, in one embodiment, step S12 comprises the following sub-steps.

At step S122, the method determines interval interactive relevance between the first user and the second user within a first time interval according to the first interactive attribute and the second interactive attribute within the first time interval in the multimedia resource playing process.

At step S123, the method determines the interactive relevance between the first user and the second user according to interval interactive relevance within a plurality of first time intervals in the multimedia resource playing process.

For example, in the multimedia resource playing process, interactive attributes within the first time interval can be analyzed based on comment icons input by users within the first time interval and corresponding input time, wherein the first time interval can be any time interval in the multimedia resource playing process. An overall input frequency for the plurality of comment icons within the first time interval can be analyzed or an input frequency for the first comment icon within the first time interval can be analyzed, so as to determine the interactive relevance between the first user and the second user within the first time interval according to the first interactive attribute and second interactive attribute within the first time interval. For example, if user A clicks the comment icon of smiling face at a frequency of one click per second from the first minute to the second minute, and user B clicks the comment icon of smiling face at a frequency of nine clicks every ten seconds from the first minute to the second minute, then the input frequencies of the two are similar. Therefore, it can be considered that the interactive relevance between user A and user B from the first minute to the second minute is relatively high.

In one embodiment, the interactive relevance between the first user and second user can be determined according to interval interactive relevance within a plurality of first time intervals in the multimedia resource playing process. For example, if user A clicks the comment icon of smiling face at a frequency of one click per second from the first minute to the second minute, and clicks the comment icon of crying face at a frequency of nine clicks every ten seconds from the fifth minute to the seventh minute, and user B clicks the comment icon of smiling face at a frequency of nine clicks every ten seconds from the first minute to the second minute, and clicks the comment icon of crying face at a frequency of one click per second from the fifth minute to the seventh minute, then it can be considered that the interval interactive relevance between user A and user B from the first minute to the second minute and from the fifth minute to the seventh minute are both relatively high. This approach can determine overall interactive relevance between the first user and second user according to interval interactive relevance within a plurality of first time intervals (e.g., according to the weighted average or weighted sum of the interval interactive relevance within the plurality of first time intervals), and perform recommendation according to the overall interactive relevance. The plurality of first time intervals can be continuous, intermittent, or the full time of playing the multimedia resource.

This approach can improve the accuracy and timeliness of recommendation and thereby enhance user experience.

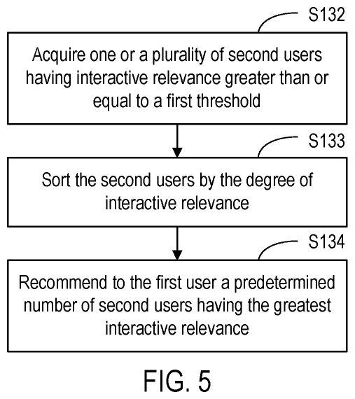

FIG. 5 is a flow diagram illustrating one embodiment of step 13 described previously, according to some embodiments of the disclosure. As shown in FIG. 5, in one embodiment, step S13 comprises the follow steps.

At step S132, the method acquires one or a plurality of second users having interactive relevance greater than or equal to a first threshold.

At step S133, the method sorts the second users by the degree of interactive relevance.

At step S134, the method recommends to the first user a predetermined number of second users having the greatest interactive relevance.

For example, interactive relevance between the first user and a plurality of second users can be determined, and a second user having interactive relevance greater than or equal to the first threshold can be acquired. The first threshold can be a preset interactive relevance threshold. For example, the first threshold can be set to 0.5-0.7 when all interactive relevance has a value range of 0-1.

In one embodiment, the second users can be sorted in descending order of interactive relevance, e.g., establishing a recommendation list of second users. The recommendation list can include a predetermined number, e.g. 10, of second users with the greatest interactive relevance. The recommendation list of second users can be recommended to the first user for the first user to choose.

This approach can improve the efficiency of recommending associated users, provide a user with more choices, and enhance user experience.

In one embodiment, the determining interactive relevance between the first user and a second user according to the first interactive attribute and a second interactive attribute of the second user can comprise: determining the interactive relevance between the first user and the second user according to the similarity between the first interactive attribute and the second interactive attribute.

For example, whether or not the first user and the second user are relevant can be determined according to whether or not the input frequencies, overall input frequencies, time distributions, or overall time distributions illustrated above are similar. Higher similarity indicates higher interactive relevance. Those skilled in the art can determine the similarity between the first interactive attribute and the second interactive attribute by any appropriate means (for example, according to the difference between frequencies, the distance between time distribution curves, etc.) to facilitate judgment of the interactive relevance, which is not limited in the disclosure.

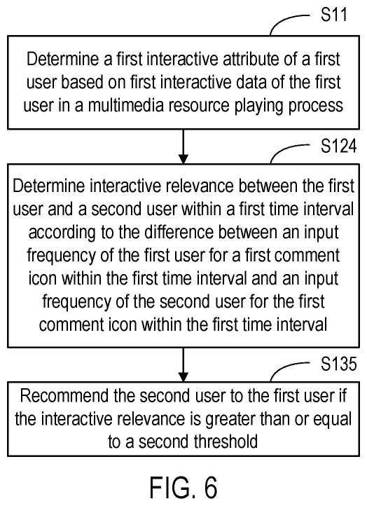

A specific example is given below with reference to FIG. 6.

FIG. 6 is a flow diagram illustrating a method for recommending an associated user according to some embodiments of the disclosure.

As shown in FIG. 6, in one embodiment, step S12 (described above) further comprises, at step S124, determining the interactive relevance between the first user and the second user within the first time interval according to the difference between the input frequency of the first user for the first comment icon within the first time interval and the input frequency of the second user for the first comment icon within the first time interval.

As shown in FIG. 6, in one embodiment, step S13 (described above) further comprises, at step S135, recommending the second user to the first user if the interactive relevance is greater than or equal to a second threshold.

For example, the first interactive attribute can comprise the input frequency of the first user for the first comment icon within the first time interval, and the second interactive attribute can comprise the input frequency of the second user for the first comment icon within the first time interval, wherein the first time interval can be any time interval in the multimedia resource playing process. Thus, the interactive relevance between the first user and the second user within the first time interval can be determined according to the difference between the input frequency of the first user for the first comment icon within the first time interval and the input frequency of the second user for the first comment icon within the first time interval. If the difference is small, it can be determined that the interactive relevance is great; if the difference is large, it can be determined that the interactive relevance is small.

In one embodiment, the second threshold of interactive relevance can be preset. For example, the second threshold can be set to 0.6-0.8 when all interactive relevance has a value range of 0-1. If the interactive relevance is greater than or equal to the second threshold, it can be determined that the first user and the second user are associated within the first time interval, the second user can be determined as an associated user of the first user, and the second user can therefore be recommended to the first user.

This approach can perform recommendation according to the difference between input frequencies for the first comment icon and improve the accuracy of recommendation.

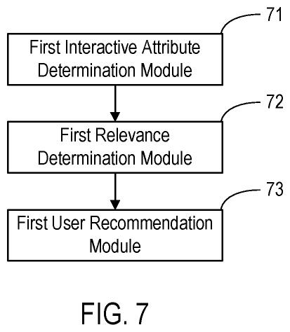

FIG. 7 is a block diagram illustrating an apparatus for recommending an associated user according to some embodiments of the disclosure.

As shown in FIG. 7, the apparatus for recommending an associated user comprises: a first interactive attribute determination module 71, a first relevance determination module 72, and a first user recommendation module 73.

The first interactive attribute determination module 71 is used to determine a first interactive attribute of a first user based on first interactive data of the first user in a multimedia resource playing process.

The first relevance determination module 72 is used to determine interactive relevance between the first user and a second user according to the first interactive attribute and a second interactive attribute of the second user.

The first user recommendation module 73 is used to recommend, according to the interactive relevance, the second user associated with the first user.

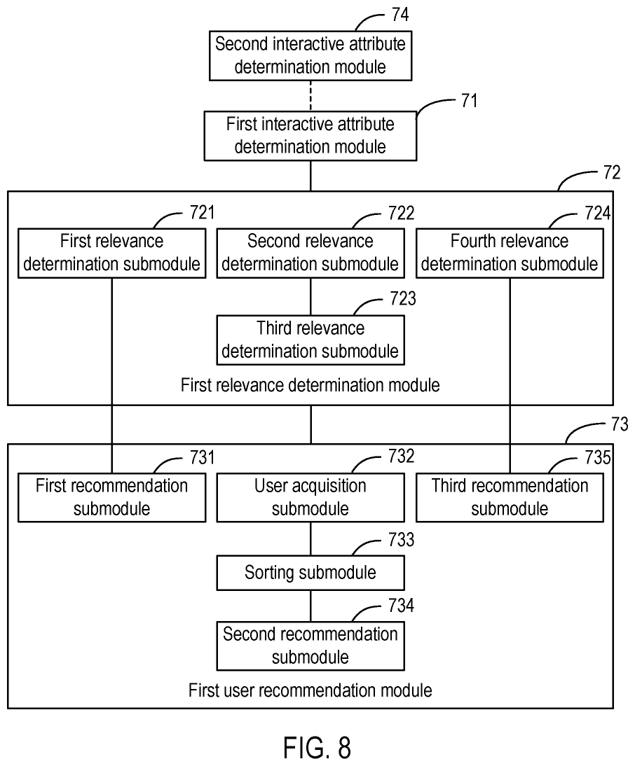

FIG. 8 is a block diagram illustrating an apparatus for recommending an associated user according to some embodiments of the disclosure. As shown in FIG. 8, in one embodiment, the apparatus further comprises a second interactive attribute determination module 74 is configured to determine the second interactive attribute of the second user based on second interactive data of the second user in the multimedia resource playing process.

As shown in FIG. 8, in one embodiment, the first relevance determination module 72 comprises a first relevance determination submodule 721 configured to determine the interactive relevance between the first user and the second user within a first time interval according to the first interactive attribute and the second interactive attribute within the first time interval in the multimedia resource playing process.

In the illustrated embodiment, the first user recommendation module 73 comprises a first recommendation submodule 731 configured to recommend the second user associated with the first user within the first time interval.

As shown in FIG. 8, in one embodiment, the first relevance determination module 72 comprises a second relevance determination submodule 722 and a third relevance determination submodule 723.

In the illustrated embodiment, the second relevance determination submodule 722 is configured to determine interval interactive relevance between the first user and the second user within a first time interval according to the first interactive attribute and the second interactive attribute within the first time interval in the multimedia resource playing process.

In the illustrated embodiment, the third relevance determination submodule 723 is configured to determine the interactive relevance between the first user and the second user according to interval interactive relevance within a plurality of first time intervals in the multimedia resource playing process.

As shown in FIG. 8, in one embodiment, the first user recommendation module 73 comprises a user acquisition submodule 732, a sorting submodule 733, and a second recommendation submodule 734.

In the illustrated embodiment, the user acquisition submodule 732 is configured to acquire one or a plurality of second users having interactive relevance greater than or equal to a first threshold;

In the illustrated embodiment, the sorting submodule 733 is configured to sort the second user by the degree of interactive relevance; and

In the illustrated embodiment, the second recommendation submodule 734 is configured to recommend to the first user a predetermined number of second users having the greatest interactive relevance.

In one embodiment, the first relevance determination module is used to determine the interactive relevance between the first user and the second user according to the similarity between the first interactive attribute and the second interactive attribute.

In one embodiment, the first interactive data comprises a comment icon input by the first user in the multimedia resource playing process and corresponding input time. In this embodiment, the first interactive attribute of the first user comprises one or a plurality of an input frequency of the first user for a first comment icon, an overall input frequency for a plurality of comment icons, an input time distribution for the first comment icon, and an overall input time distribution for the plurality of comment icons, wherein the first comment icon is any one of the plurality of comment icons.

In one embodiment, the second interactive data comprises a comment icon input by the second user in the multimedia resource playing process and corresponding input time and the second interactive attribute comprises one or a plurality of an input frequency of the second user for the first comment icon, an overall input frequency for the plurality of comment icons, an input time distribution for the first comment icon, and an overall input time distribution for the plurality of comment icons, wherein the first comment icon is any one of the plurality of comment icons.

In one embodiment, the first interactive attribute comprises an input frequency of the first user for the first comment icon within a first time interval, and the second interactive attribute comprises an input frequency of the second user for the first comment icon within the first time interval.

As shown in FIG. 8, in one embodiment, the first relevance determination module 72 comprises a fourth relevance determination submodule 724.

In the illustrated embodiment, the fourth relevance determination submodule 724 is configured to determine the interactive relevance between the first user and the second user within the first time interval according to the difference between the input frequency of the first user for the first comment icon within the first time interval and the input frequency of the second user for the first comment icon within the first time interval.

In the illustrated embodiment, the first user recommendation module 73 further comprises a third recommendation submodule 735 is configured to recommend the second user to the first user if the interactive relevance is greater than or equal to a second threshold.

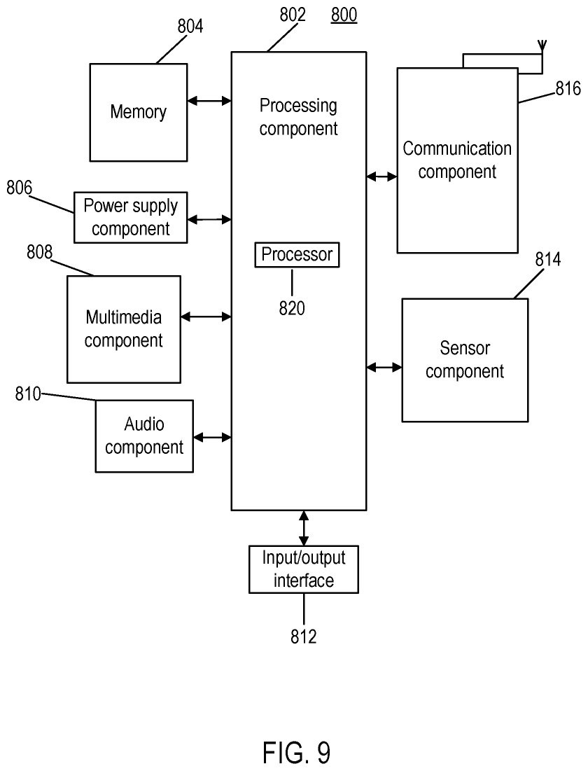

FIG. 9 is a block diagram illustrating an apparatus 800 for recommending an associated user according to some embodiments of the disclosure.

For example, the apparatus 800 can be a mobile phone, a computer, a digital broadcasting terminal, a messaging device, a game console, a tablet device, medical equipment, fitness equipment, a personal digital assistant, etc.

Referring to FIG. 9, the apparatus 800 can comprise one or a plurality of the following components: a processing component 802, a memory 804, a power supply component 806, a multimedia component 808, an audio component 810, an input/output (I/O) interface 812, a sensor component 814, and a communication component 816.

The processing component 802 usually controls overall operations of the apparatus 800, such as operations associated with display, telephone call, data communication, camera, and recording. The processing component 802 can comprise one or a plurality of processors 820 for executing instructions to accomplish all or part of the steps of the above-described method. Furthermore, the processing component 802 can comprise one or a plurality of modules to facilitate interaction between the processing component 802 and other components. For example, the processing component 802 can comprise a multimedia module to facilitate interaction between the multimedia component 808 and the processing component 802.

The memory 804 is configured to store various types of data to support operation on the apparatus 800. Examples of these data include instructions for any application or method operating on the apparatus 800, contact data, phonebook data, messages, pictures, videos, etc. The memory 804 can be implemented by any type of volatile or nonvolatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power supply component 806 provides power to various components of the apparatus 800. The power supply component 806 can comprise a power management system, one or a plurality of power supplies, and other components associated with generating, managing, and distributing power for the apparatus 800.

The multimedia component 808 comprises a screen providing an output interface between the apparatus 800 and a user. In some embodiments, the screen can comprise a liquid crystal display (LCD) and a touch panel (TP). If the screen comprises a touch panel, the screen can be implemented as a touch screen to receive input signals from the user. The touch panel includes one or a plurality of touch sensors to sense touches, swipes, and gestures on the touch panel. The touch sensors may not only sense a boundary of a touch or swipe action, but also detect a period of time and a pressure related to the touch or swipe operation. In some embodiments, the multimedia component 808 comprises a front camera and/or a rear camera. When the apparatus 800 is in an operation mode such as a shooting mode or a video mode, the front camera and/or the rear camera can receive external multimedia data. Each front camera and rear camera can be a fixed optical lens system or have a focal length and optical zoom capability.

The audio component 810 is configured to output and/or input audio signals. For example, the audio component 810 comprises a microphone (MIC), which is configured to receive external audio signals when the apparatus 800 is in an operation mode such as a call mode, a recording mode, and a voice recognition mode. The received audio signals can be further stored in the memory 804 or sent via the communication component 816. In some embodiments, the audio component 810 further comprises a speaker used to output audio signals.

The I/O interface 812 provides an interface between the processing component 802 and a peripheral interface module, which can be a keyboard, a click wheel, a button, etc. These buttons can include, but are not limited to, a home button, a volume button, a start button, and a lock button.

The sensor component 814 comprises one or a plurality of sensors used to provide the apparatus 800 with a status evaluation of various aspects. For example, the sensor component 814 can detect the on/off state of the apparatus 800 and relative positioning of components, for example, the components are the display and keypad of the apparatus 800; the sensor component 814 can also detect position change of the apparatus 800 or one component of the apparatus 800, the presence or absence of user contact with the apparatus 800, the orientation or acceleration/deceleration of the apparatus 800, and temperature change of the apparatus 800. The sensor component 814 can comprise a proximity sensor configured to detect the presence of a nearby object when there is no physical contact. The sensor component 814 can further comprise a light sensor, such as a CMOS or CCD image sensor, for use in an imaging application. In some embodiments, the sensor component 814 can further comprise an acceleration sensor, a gyroscope sensor, a magnetic sensor, a pressure sensor, or a temperature sensor.

The communication component 816 is configured to facilitate wired or wireless communication between the apparatus 800 and other devices. The apparatus 800 can access a wireless network based on a communication standard, such as WiFi, 2G, 3G, or a combination thereof. In one exemplary embodiment, the communication component 816 receives broadcasting signals from an external broadcast management system or broadcast related information via a broadcast channel. In one exemplary embodiment, the communication component 816 further comprises a near field communication (NFC) module to facilitate short-range communication. For example, the NFC module can be implemented based on radio frequency identification (RFID) technology, Infrared Data Association (IrDA) technology, ultra-wide band (UWB) technology, BlueTooth (BT) technology, and other technologies.

In an exemplary embodiment, the apparatus 800 can be implemented by one or a plurality of application-specific integrated circuits (ASICs), digital signal processors (DSPs), digital signal processing devices (DSPDs), programmable-logic devices (PLDs), field-programmable gate arrays (FPGAs), controllers, microcontrollers, microprocessors, or other electronic elements for performing the above-described method.

In an exemplary embodiment, a non-volatile computer-readable storage medium including instructions is further provided, e.g., the memory 804 including instructions, and the abovementioned instructions can be executed by the processor 820 of the apparatus 800 to accomplish the above-described method.

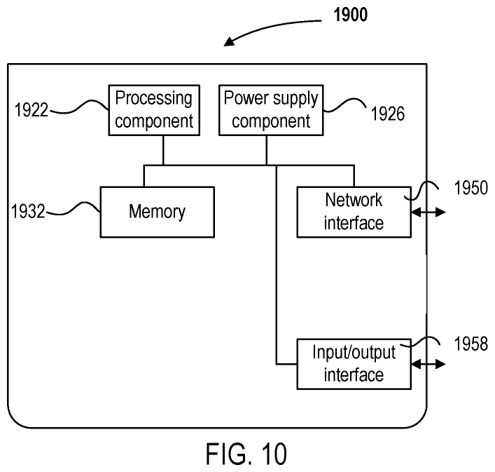

FIG. 10 is a block diagram illustrating an apparatus 1900 for recommending an associated user according to some embodiments of the disclosure.

For example, the apparatus 1900 can be utilized as a server. Referring to FIG. 10, the apparatus 1900 comprises a processing component 1922 that further comprises one or a plurality of processors, and a memory resource represented by a memory 1932 used to store instructions that can be executed by the processing component 1922, e.g., an application. The application stored in the memory 1932 can comprise one or a plurality of modules each corresponding to a set of instructions. Furthermore, the processing component 1922 is configured to execute instructions for performing the above-described method.

The apparatus 1900 can further comprise a power supply component 1926 configured to perform power management for the apparatus 1900, a wired or wireless network interface 1950 configured to connect the apparatus 1900 to a network, and an input/output (I/O) interface 1958. The apparatus 1900 can operate based on an operating system stored in the memory 1932, such as Windows Server™, Mac OS X™, Unix™, Linux™, FreeBSD™, or the like.

In an exemplary embodiment, a non-volatile computer-readable storage medium including instructions is further provided, e.g., the memory 1932 including instructions, and the abovementioned instructions can be executed by the processing component 1922 of the apparatus 1900 to accomplish the above-described method.

The disclosure can be a system, method, and/or computer program product. The computer program product can comprise a computer-readable storage medium having computer-readable program instructions carried thereon for causing a processor to implement various aspects of the disclosure.

The computer-readable storage medium can be a tangible device that can hold and store instructions used by instruction execution device. The computer-readable storage medium may be, for example, but is not limited to an electrical storage device, a magnetic storage device, an optical storage device, an electromagnetic storage device, a semiconductor memory device, or any suitable combination thereof. More specific examples of the computer readable storage medium (a non-exhaustive list) include: a portable computer disk, a hard disk, a random access memory (RAM), a read only memory (ROM), a erasable programmable read only memory (EPROM or flash memory), a static random access memory (SRAM), a portable compact disc read-only memory (CD ROM), a digital versatile disk (DVD), a memory stick, a floppy disk, a mechanical coding equipment, such as a punch card with instructions stored thereon or a structure of bumps within recessions, and any suitable combination thereof. The computer-readable storage medium used herein is not interpreted as transient signals themselves, such as radio waves or other freely propagated electromagnetic waves, electromagnetic waves propagated through a waveguide or other transmission media (e.g., light pulses passing through a fiber optic cable), or electrical signals transmitted through electric wires.

The computer readable program instructions described herein may be downloaded from a computer-readable storage medium to various computing/processing devices or downloaded to an external computer or external storage device via a network such as the Internet, a local area network, a wide area network and/or a wireless network. The network may include copper transmission cables, fiber transmission, wireless transmission, routers, firewalls, switches, gateway computers, and/or edge servers. A network adapter card or a network interface in each computing/processing device receives computer-readable program instructions from the network and forwards the computer readable program instructions, for storing them in a computer readable storage medium in each computing/processing device.

Computer program instructions for performing the operations of the disclosure can be assembly instructions, instruction set architecture (ISA) instructions, machine instructions, machine related instructions, microcode, firmware instructions, state setting data, or source code or object code written in any combination of one or a plurality of programming languages, the programming languages including object-oriented programming languages such as Smalltalk, C++, and the like, and conventional procedural programming languages such as “C” language or similar programming languages. The computer-readable program instructions can be executed entirely or partly on a user computer, executed as a stand-alone software package, executed partly on a user computer and partly on a remote computer, or executed entirely on a remote computer or server. In the case of a remote computer, the remote computer may be connected to the user's computer through any kind of network, including a local area network (LAN) or a wide area network (WAN). Alternatively, it can be connected to an external computer (for example, using an Internet service provider to connect via the Internet). In some embodiments, electronic circuits, such as programmable logic circuits, field-programmable gate arrays (FPGAs), or programmable logic arrays (PLAs), are customized by utilizing state information of computer-readable program instructions. The electronic circuits can execute computer-readable program instructions to implement various aspects of the disclosure.

The various aspects of the disclosure are described herein with reference to the flow diagrams and/or block diagrams of the methods, apparatuses (systems), and computer program products according to the embodiments of the disclosure. It should be understood that, each block of the flowcharts and/or block diagrams and combinations of various blocks in the flowcharts and/or block diagrams can be implemented by computer readable program instructions.

These computer program instructions may be provided to a processor of a general-purpose computer, a special-purpose computer or other programmable data processing apparatuses, to produce a machine, so that these instructions, when executed by the processor of the computer or other programmable data processing apparatuses, produce an apparatus for implementing the functions/actions specified in one or a plurality of the blocks of the flowcharts and/or block diagrams. Also, these computer readable program instructions may be stored in a computer readable storage medium. These instructions cause a computer, a programmable data processing device, and/or other devices to work in a specific manner; thus, the computer readable medium storing the instructions includes an artifact, including instructions that implement various aspects of the functions/actions specified in one or a plurality of the flowcharts and/or block diagrams.

The computer program instructions may also be loaded onto a computer, other programmable data processing apparatuses, or other devices, such that the computer, other programmable data processing apparatuses or other devices perform a series of operational steps, to generate a computer-implemented process, such that the functions/actions specified in one or a plurality of the flowcharts and/or block diagrams are implemented by the instructions executed on the computer, other programmable data processing apparatuses, or other devices.

The flow diagrams and block diagrams in the accompanying drawings illustrate system architectures, functions, and operations of embodiments of the systems, methods, and computer program products according to a plurality of embodiments of the disclosure. In this regard, each block in the flowcharts or block diagrams may represent a portion of a module, program segment, or instruction that contains one or a plurality of executable instructions for implementing the specified logical functions. In some alternative implementations, the functions denoted in the blocks can also occur in a different order than that illustrated in the drawings. For example, two consecutive blocks can actually be performed substantially in parallel, sometimes can also be performed in a reverse order, depending upon the functions involved. It is also noted that each block of the block diagrams and/or flowcharts, and combinations of blocks in the block diagrams and/or flowcharts can be implemented in a dedicated hardware-based system that performs the specified function or action, or can be implemented by a combination of dedicated hardware and computer instructions.

The various embodiments of the disclosure have been described above. The foregoing description is exemplary and non-exhaustive, and is not limited to the various embodiments disclosed. Many modifications and variations are apparent to those of ordinary skill in the art without departing from the scope and spirit of the various embodiments illustrated. The terminology used herein was chosen to best explain the principles of the embodiments, the practical application or technical improvement over technologies found in the marketplace, or to enable others of ordinary skill in the art to understand the embodiments disclosed herein.

1-19. (canceled)

20. A method comprising:
determining a first interactive attribute of a first user based on first interactive data of the first user during a multimedia resource playing process;
determining interactive relevance between the first user and at least one second user based on the first interactive attribute and a second interactive attribute of the second user; and
recommending, based on the interactive relevance, the second user to the first user.

21. The method of claim 20, further comprising determining the second interactive attribute of the second user based on second interactive data of the second user in the multimedia resource playing process.

22. The method of claim 21, the first interactive data comprising a comment icon input by the first user in the multimedia resource playing process and a corresponding input time; the first interactive attribute of the first user comprising one or a plurality of an input frequency of the first user for a first comment icon, an overall input frequency for a plurality of comment icons, an input time distribution for the first comment icon, and an overall input time distribution for the plurality of comment icons.

23. The method of claim 22, wherein the second interactive data comprises a second comment icon input by the second user in the multimedia resource playing process and a corresponding second input time; the second interactive attribute comprises one or a plurality of an input frequency of the second user for the first comment icon, an overall input frequency for the plurality of comment icons, an input time distribution for the first comment icon, and an overall input time distribution for the plurality of comment icons.

24. The method of claim 23, the first interactive attribute comprising an input frequency of the first user for the first comment icon within a time interval, and the second interactive attribute comprises an input frequency of the second user for the first comment icon within the time interval and the determining interactive relevance between the first user and a plurality of second users based on the first interactive attribute and second interactive attributes of the plurality of second users comprises determining the interactive relevance between the first user and the second user within the time interval based on the difference between the input frequency of the first user for the first comment icon within the time interval and the input frequency of the second user for the first comment icon within the time interval; and the recommending, based on the interactive relevance, the second user associated with the first user comprises recommending the second user to the first user if the interactive relevance is greater than or equal to a second threshold.

25. The method of claim 20,
the determining interactive relevance between the first user and the at least one second user comprising determining the interactive relevance between the first user and the second user within a time interval based on the first interactive attribute and the second interactive attribute occurring within the time interval in the multimedia resource playing process; and
the recommending the second user associated with the first user comprising recommending the second user associated with the first user within the time interval.

26. The method of claim 20,
the determining interactive relevance between the first user and the at least one second user comprising determining an interval interactive relevance between the first user and the second user within a time interval based on the first interactive attribute and the second interactive attribute occurring within the time interval in the multimedia resource playing process; and
determining the interactive relevance between the first user and the second user based on interval interactive relevance within a plurality of time intervals in the multimedia resource playing process.

27. The method of claim 20, the recommending the second user associated with the first user comprising:
acquiring a plurality of second users having interactive relevance greater than or equal to a first threshold;
sorting the plurality of second users by the degree of interactive relevance; and
recommending to the first user a predetermined number of second users from the plurality of second users, the predetermined number of second users having a greatest interactive relevance.

28. The method of claim 20, the determining interactive relevance between the first user and the at least one second user comprising determining the interactive relevance between the first user and the at least one second user based on the similarity between the first interactive attribute and the second interactive attribute.

29. A non-transitory computer readable storage medium for tangibly storing computer program instructions capable of being executed by a computer processor, the computer program instructions defining the steps of:
determining a first interactive attribute of a first user based on first interactive data of the first user during a multimedia resource playing process;
determining interactive relevance between the first user and at least one second user based on the first interactive attribute and a second interactive attribute of the second user; and
recommending, based on the interactive relevance, the second user to the first user.

30. The non-transitory computer readable storage medium of claim 29, the computer program instructions further defining the step of determining the second interactive attribute of the second user based on second interactive data of the second user in the multimedia resource playing process.

31. The non-transitory computer readable storage medium of claim 30, the first interactive data comprising a comment icon input by the first user in the multimedia resource playing process and a corresponding input time; the first interactive attribute of the first user comprising one or a plurality of an input frequency of the first user for a first comment icon, an overall input frequency for a plurality of comment icons, an input time distribution for the first comment icon, and an overall input time distribution for the plurality of comment icons.

32. The non-transitory computer readable storage medium of claim 31, wherein the second interactive data comprises a second comment icon input by the second user in the multimedia resource playing process and a corresponding second input time; the second interactive attribute comprises one or a plurality of an input frequency of the second user for the first comment icon, an overall input frequency for the plurality of comment icons, an input time distribution for the first comment icon, and an overall input time distribution for the plurality of comment icons.

33. The non-transitory computer readable storage medium of claim 32, the first interactive attribute comprising an input frequency of the first user for the first comment icon within a time interval, and the second interactive attribute comprises an input frequency of the second user for the first comment icon within the time interval and the determining interactive relevance between the first user and a plurality of second users based on the first interactive attribute and second interactive attributes of the plurality of second users comprises determining the interactive relevance between the first user and the second user within the time interval based on the difference between the input frequency of the first user for the first comment icon within the time interval and the input frequency of the second user for the first comment icon within the time interval; and the recommending, based on the interactive relevance, the second user associated with the first user comprises recommending the second user to the first user if the interactive relevance is greater than or equal to a second threshold.

34. The non-transitory computer readable storage medium of claim 29,
the determining interactive relevance between the first user and the at least one second user comprising determining the interactive relevance between the first user and the second user within a time interval based on the first interactive attribute and the second interactive attribute occurring within the time interval in the multimedia resource playing process; and
the recommending the second user associated with the first user comprising recommending the second user associated with the first user within the time interval.

35. The non-transitory computer readable storage medium of claim 29,
the determining interactive relevance between the first user and the at least one second user comprising determining an interval interactive relevance between the first user and the second user within a time interval based on the first interactive attribute and the second interactive attribute occurring within the time interval in the multimedia resource playing process; and
determining the interactive relevance between the first user and the second user based on interval interactive relevance within a plurality of time intervals in the multimedia resource playing process.

36. The non-transitory computer readable storage medium of claim 29, the recommending the second user associated with the first user comprising:
acquiring a plurality of second users having interactive relevance greater than or equal to a first threshold;
sorting the plurality of second users by the degree of interactive relevance; and
recommending to the first user a predetermined number of second users from the plurality of second users, the predetermined number of second users having a greatest interactive relevance.

37. The non-transitory computer readable storage medium of claim 29, the determining interactive relevance between the first user and the at least one second user comprising determining the interactive relevance between the first user and the at least one second user based on the similarity between the first interactive attribute and the second interactive attribute.

38. A device comprising:
a processor; and
a storage medium for tangibly storing thereon program logic for execution by the processor, the stored program logic comprising:
logic, executed by the processor, for determining a first interactive attribute of a first user based on first interactive data of the first user during a multimedia resource playing process;
logic, executed by the processor, for determining interactive relevance between the first user and at least one second user based on the first interactive attribute and a second interactive attribute of the second user; and
logic, executed by the processor, for recommending, based on the interactive relevance, the second user to the first user.

39. The device of claim 38, the determining interactive relevance between the first user and the at least one second user comprising determining the interactive relevance between the first user and the at least one second user based on the similarity between the first interactive attribute and the second interactive attribute.
